(19) United States
(12) Patent Application Publication
(10) Pub. No.: US 2009/0138166 A1
(43) Pub. Date: May 28, 2009

(54) Multiplexed Hydraulic Control for a Two-Coupling All-Wheel Drive System

(76) Inventor: David E. Bruder, Novi, MI (US)

Correspondence Address: Philip R. Warn;Warn Partners, P.C., P.O. Box 70098, Rochester Hills, MI, 48307, US

(21) Appl. No.: 12/083,021

(22) PCT Filed: Oct. 5, 2006
(86) PCT No.: PCT/US2006/039009

§ 371 Date: Apr. 2, 2008

Related U.S. Application Data
(60) Provisional application No. 60/724,331, filed on Oct. 6, 2005.

(51) Int. Cl. G06F 17/00; F16D 48/06; B60K 23/08

(52) U.S. Cl. 701/69; 192/58.61; 180/247

(57) ABSTRACT

The present invention is directed toward incorporating a single actuation unit to actuate two or more couplings. The clutch actuation arrangement has a first coupling (36) connected to a first valve (32), a second coupling (38) connected to a second valve (34), and an actuator (24) operably connected to the first valve (32) and the second valve (34). The first valve (32) and the second valve (34) control fluid flow to the first coupling (36) and the second coupling (38). The clutch actuation arrangement also includes an elongated cylinder (31) operably connected to the first valve (32) and second valve (34). A piston (30) is slidably disposed in the elongated cylinder (31), wherein the piston (30) controls the amount of pressure presented to the first and second valves (32,34). The clutch actuation arrangement also includes a ball screw (28) connected to the piston (31), a motor (26) operably connected to the ball screw (28), wherein the motor (26) rotates the ball screw (28) to translate the piston (30) in the elongated cylinder (31).

This application claims the benefit of U.S. Provisional Application No. 60/724,331, filed Oct. 6, 2005.

### FIELD OF THE INVENTION

The present invention relates to the control of hydraulic couplings used in a vehicle having a limited slip differential and all-wheel drive capability.

### BACKGROUND OF THE INVENTION

Motor vehicles which use all-wheel drive capability are generally known. All-wheel drive capability improves vehicle stability, control, as well as handling, especially when driving during conditions when the road is slippery, caused by rain or snow. All-wheel drive can also improve vehicle performance on non-paved surfaces as well, such as gravel or dirt.

Implementing all-wheel drive capability into a vehicle can be accomplished in several ways, one of which includes the use of a hydraulic coupling. The hydraulic coupling is essentially a clutch pack assembly actuated by hydraulic fluid, and allows power to be transferred to a secondary set of wheels as dictated by various driving conditions. For example, a vehicle which is primarily front-wheel drive may incorporate the use of a coupling to transfer some of the power from the engine to the rear wheels when needed. A hydraulic coupling can also be used to serve as a limited slip differential (LSD) for the front or rear wheels. For example, if the hydraulic coupling is being used as an LSD for the rear wheels, the coupling can balance the power delivered to the right rear wheel and left rear wheel. The coupling can also be fully engaged, making the right and left rear wheels rotate together, and behave as if the vehicle has a solid rear axle.

Incorporating the use of two hydraulic couplings can have an even greater effect on improving vehicle handling and stability. One coupling can be used to transfer power to a secondary set of wheels, and another coupling can be used to balance the power distribution between the right wheel and left wheel for that same set of wheels. Essentially, two hydraulic couplings can be used on one set of wheels. However designs using multiple clutches encounter packaging problems. Clutches used in transmissions, transfer cases, differential assemblies, and the like, all occupy space within the vehicle, and the components used to actuate clutches used in various applications occupy space as well. Due to increasing standards for reductions in size and vehicle weight, there exists a need to reduce the number of components used to actuate clutch assemblies.

### SUMMARY OF THE INVENTION

The present invention is directed toward incorporating a single actuation unit to actuate two or more couplings. The clutch actuation arrangement has a first coupling connected to a first valve, a second coupling connected to a second valve, and an actuator operably connected to the first valve and the second valve. The first valve and the second valve control the flow of fluid to the first coupling and the second coupling.

The clutch actuation arrangement also includes an elongated cylinder operably connected to the first and second valves. A piston is slidably disposed in the elongated cylinder, wherein the piston controls the amount of pressure presented to the first and second valves. The clutch actuation arrangement also has a ball screw connected to the piston, a motor operably connected to the ball screw, wherein the motor rotates the ball screw to translate the piston in the elongated cylinder.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a diagram of a vehicle powertrain incorporating the present invention;

FIG. 2 is a flow diagram showing each element of the present invention;

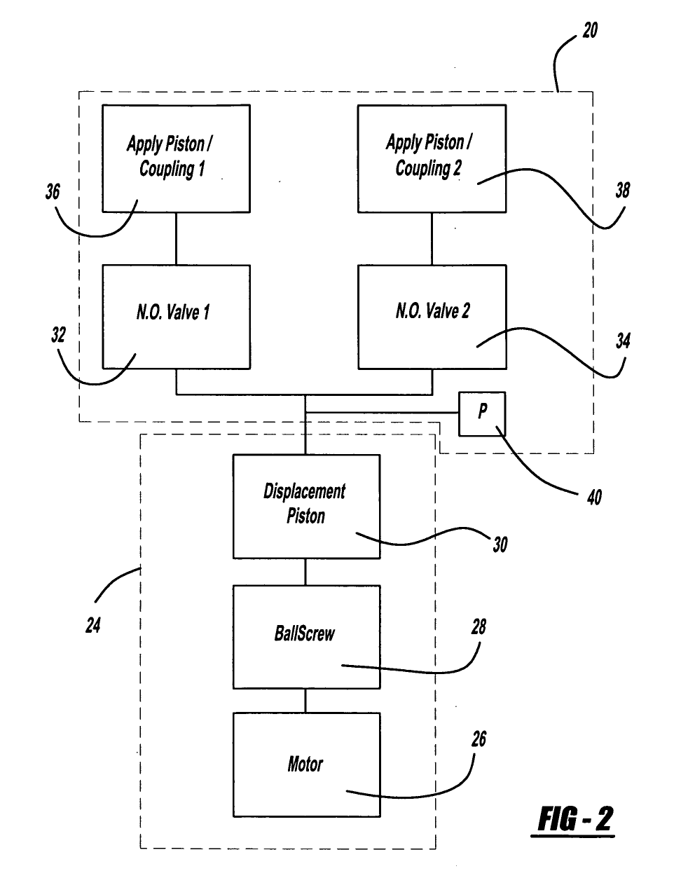

FIG. 3 is an isometric view of a two-coupling all-wheel drive unit, according to the present invention;

FIG. 4 is an isometric view of two couplings connected by a hydraulic fluid line, according to the present invention;

FIG. 5 is an angled side view of a two-coupling all-wheel drive unit, according to the present invention;

FIG. 6 is an angled front view of a two-coupling all-wheel drive unit, according to the present invention;

FIG. 7 is an enlarged view of a hydraulic actuator assembly incorporating the use of two valves used to operate two separate couplings, according to the present invention; and

FIG. 8 is a bottom view of a hydraulic actuator assembly incorporating the use of two valves used to operate two separate couplings, according to the present invention.

### DETAILED DESCRIPTION OF THE PREFERRED EMBODIMENTS

The following description of the preferred embodiment(s) is merely exemplary in nature and is in no way intended to limit the invention, its application, or uses.

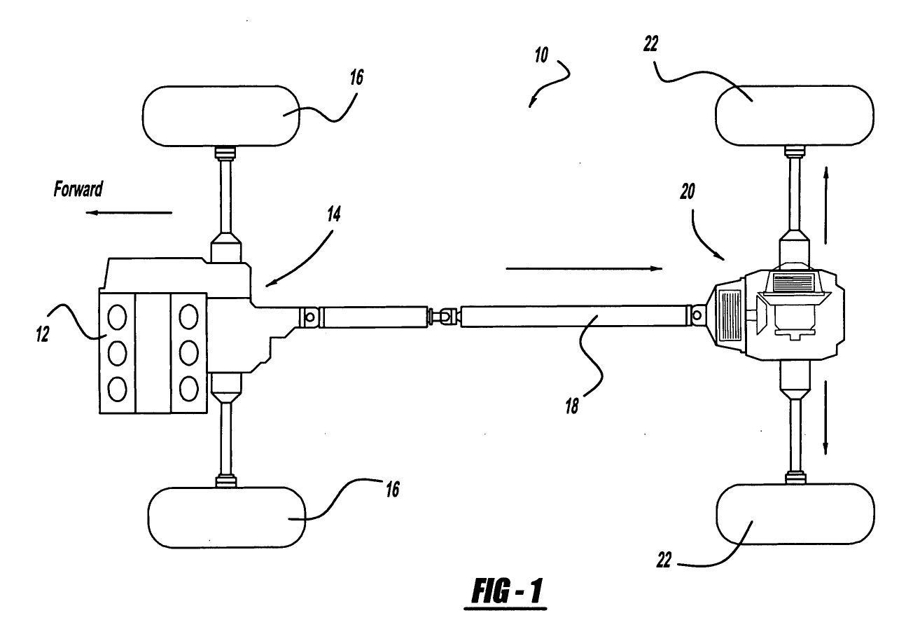

Referring now to FIG. 1, a vehicle incorporating use of the present invention is shown at 10. The vehicle 10 has a primary mover 12 connected to a transmission 14. The transmission 14 delivers power to a primary set of wheels 16, and a drive shaft 18. The drive shaft 18 is connected to a two-coupling all-wheel drive (AWD) device 20. The two-coupling AWD device 20 is connected to a secondary set of wheels 22. Although the vehicle 10 shown in FIG. 1 shows the primary set of wheels 16 as the front wheels, and the secondary set of wheels 22 as the rear wheels, the primary set of wheels 16 could be the rear wheels, and the secondary set of wheels 22 could be the front wheels.

Referring to Figures generally, the two-coupling AWD device 20 of the present invention includes an actuator 24 having an electric motor 26, a ball screw 28, and a displacement piston 30 located in an elongated cylinder 31. The actuator 24 is used for directing fluid through a first valve 32, and a second valve 34. The first valve 32 is connected to a first coupling 36, and the second valve 34 is connected to a second coupling 38. A pressure transducer 40 is located between the first valve 32 and the second valve 34. The actuator 24 is controlled by the vehicle's electronic control unit (ECU), not shown, and will direct fluid to either the first coupling 36 or the second coupling 38. The ECU also controls the first valve 32 and second valve 34.

The movement of fluid is accomplished as follows, the ECU will actuate the actuator 24 to direct flow through either the first valve 32, or the second valve 34, depending upon the operating conditions of the vehicle. Once the operating conditions reach certain predetermined values, the motor 26 will actuate the ball screw 28, the ball screw 28 will then move the displacement piston 30 in the elongated cylinder 31, directing fluid through either first valve 32 or second valve 34, depending upon if the first coupling 36 or second coupling 38 needs to be actuated. The fluid directed through the first valve 32 will actuate the first coupling 36, and fluid directed through the second valve will actuate the second coupling 38. The first coupling 36 is used to control power distribution from the prime mover 12 between the primary set of wheels 16 and the secondary set of wheels 22. The second coupling 38 is used to control power distribution between each of the secondary wheels 22.

During operation, the ECU will command the actuator 24 to alternate control over the first valve 32 and the second valve 34 every 20-100 ms, allowing the power transfer through the first coupling 36 and the second coupling 38 to appear seamless to the vehicle driver.

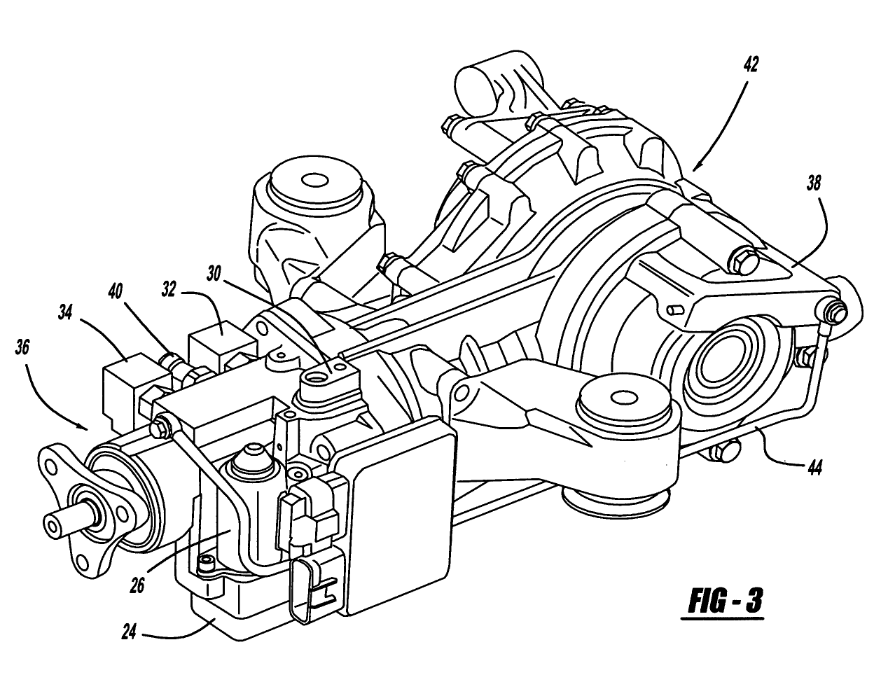

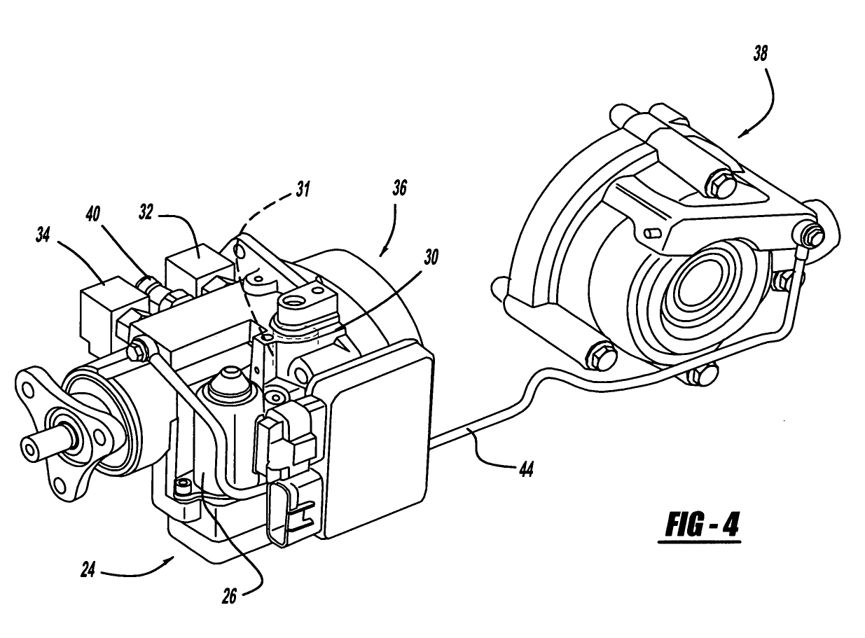

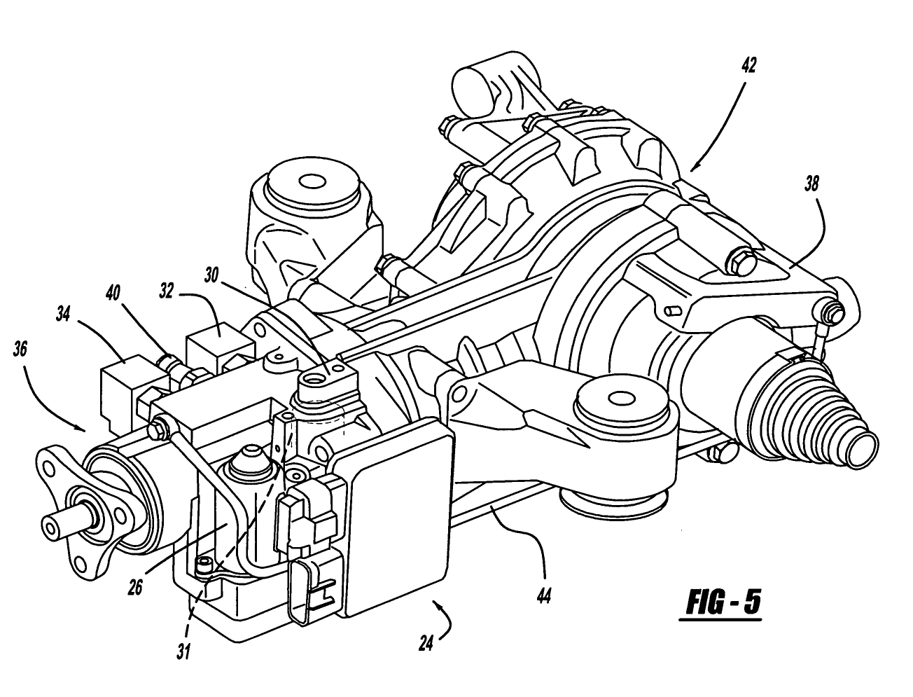

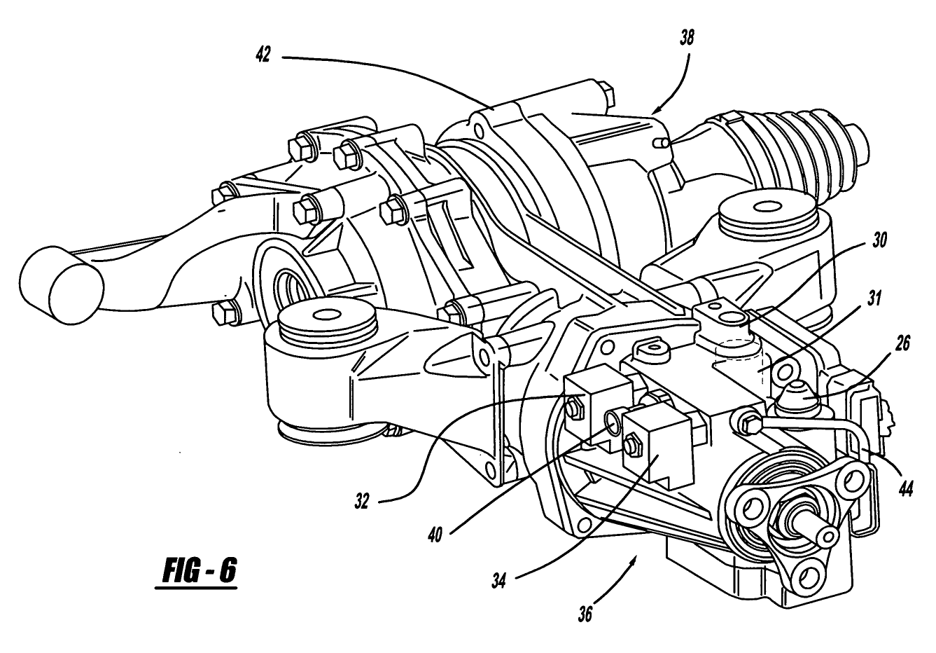

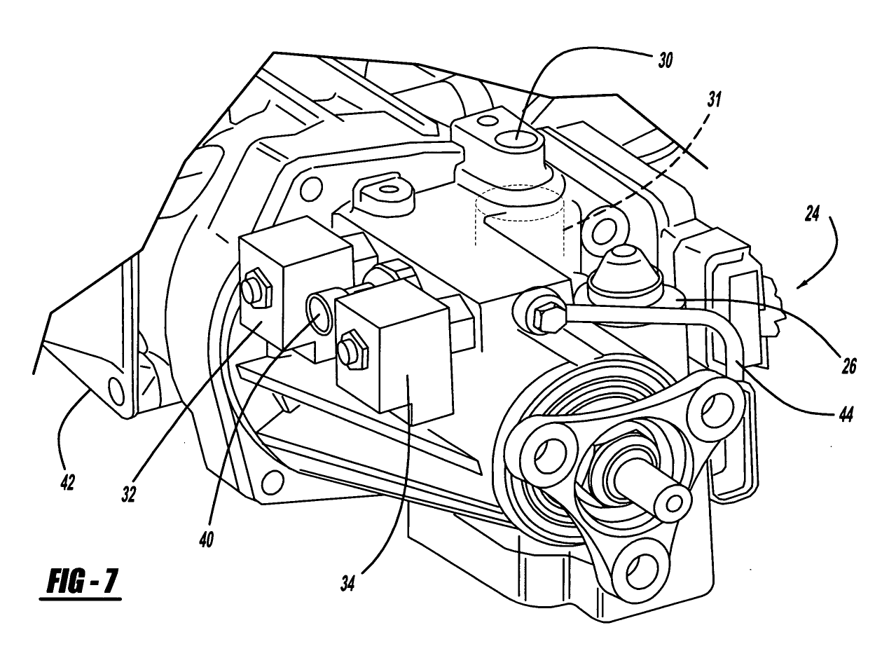

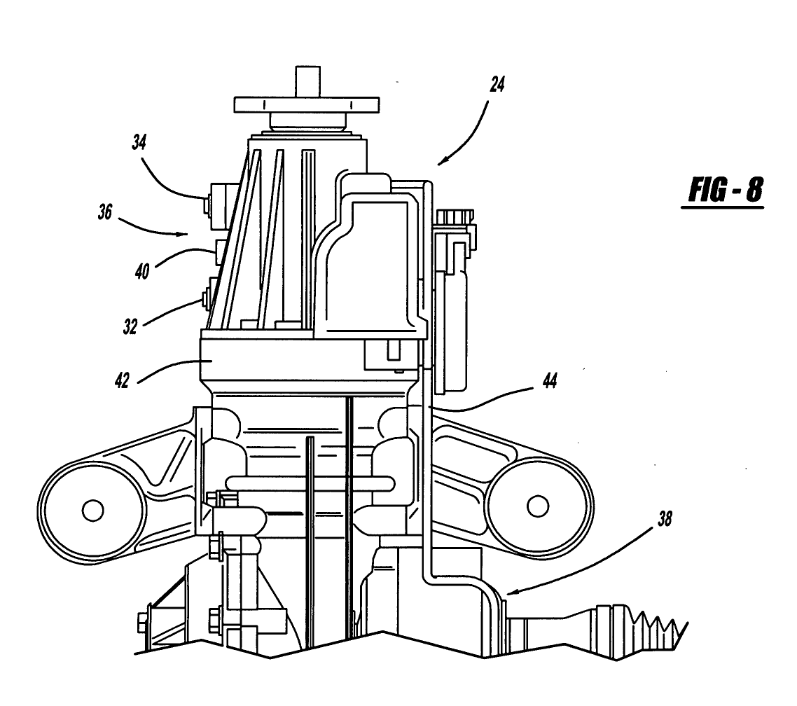

As shown in FIGS. 3-8 the first coupling 36 and the second coupling 38 are mounted onto a housing 42. Also mounted onto the housing 42 is an actuator, which in this embodiment is shown as a hydraulic actuator 24. The actuator 24 is used to actuate the first coupling 36 and the second coupling 38. As previously mentioned, the actuator 24 has an electric motor 26, a ball screw 28, a displacement piston 30, an elongated cylinder 31, and works in conjunction with a pressure transducer 40. The actuator 24 is controlled by the vehicle's electronic control unit (ECU), not shown.

In this embodiment, inside the first coupling 36 is a first clutch pack and a first hydraulic piston, and inside the second coupling 38 is a second clutch pack and a second hydraulic piston. It should be noted that the first coupling 36 and the second coupling 38 of the present invention are not limited to the use of a clutch pack and hydraulic piston. The first clutch pack and second clutch pack, along with the first and second hydraulic pistons, are not necessary to practice the concept of one actuator controlling two couplings. In alternate embodiments, the first clutch pack and second clutch pack along with the first and second hydraulic pistons are interchangeable with any device used to synchronize two rotating members.

The first coupling 36 is connected to the actuator 24 by way of the actuator 24 being mounted onto the housing 42 in the same area and being connected directly to the first coupling 36; the second coupling 38 is connected to the actuator 24 by way of a fluid passage 44.

The first coupling 36 is used to balance the amount of power delivered between the primary set of wheels 16 and the secondary set of wheels 22 in the motor vehicle 10. When the first coupling 36 is in a fully engaged position, an equal amount of power is transferred to both the primary wheels 16 and secondary wheels 22. When the first coupling 36 is in a fully disengaged position, power from the engine is transferred to the primary wheels 16 only. The first coupling 36 is also operated to balance and distribute power from the engine to the secondary wheels 22 in any amount between the fully engaged and fully disengaged positions.

The second coupling 38 is used to control the power distribution between a set of secondary wheels 22, essentially acting as a controlled limited slip differential (LSD). The range of operation of the second coupling 38 is from a fully engaged condition, where the secondary wheels 22 rotate at the same speed, receive equal amounts of power from the engine 12, and behave in similar fashion to wheels having a solid axle, to a fully open position, where the secondary wheels 22 are free to rotate at different speeds, and behave in similar manner to a set of wheels having an open differential. The second coupling 28 is also used to balance the amount of power split between the secondary wheels 22 to any range between the fully open position and fully engaged position.

The range of control of the two-coupling AWD device 20 also includes the ability to hold the first valve 32 closed after fully or partially engaging the first coupling 36, while operating the second coupling 38; the range of control also includes the ability to hold the second valve 34 closed after fully or partially engaging the second coupling 38, while operating the first coupling 36.

It should be noted that the two-coupling AWD device 20 could be incorporated into a transmission, transfer case, or other device where control over two couplings by use of one actuator is necessary due to packaging constraints, or other concerns. This system can also be used to control two couplings generally, where the actuator 24, the first valve 32, the second valve 34 can be used to direct fluid to apply pressure engaging either one of the couplings, or both at the same time.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A clutch actuation arrangement comprising;
a first coupling connected to a first valve;
a second coupling connected to a second valve; and
an actuator operably connected to said first valve and said second valve, wherein said first valve and said second valve control the flow of fluid to said first coupling and said second coupling.

2. The clutch actuation arrangement of claim 1 wherein said actuator further comprises:
an elongated cylinder operably connected to said first and second valves;
a piston slidably disposed in said elongated cylinder, wherein said piston controls the amount of pressure presented to said first and second valves.

3. The clutch actuation arrangement of claim 2 further comprising:
a ball screw connected to said piston;
a motor operably connected to said ball screw, wherein said motor rotates said ball screw to translate said piston in said elongated cylinder.

4. The clutch actuation arrangement of claim 1, wherein said first coupling includes a first clutch pack and a first hydraulic piston, and said second coupling includes a second clutch pack and a second hydraulic piston.

5. The clutch actuation arrangement of claim 1, wherein said first coupling is operably associated with a primary set of wheels, and said second coupling is operably associated with a secondary set of wheels.

6. The clutch actuation arrangement of claim 1, further comprising at least one mode of operation where said first coupling is fully engaged, said first valve is closed to maintain said first coupling in said fully engaged position, and said actuator operates said second valve to engage and disengage said second coupling to selectively distribute power to said secondary set of wheels.

7. The clutch actuation arrangement of claim 1, further comprising at least one mode of operation where said second coupling is fully engaged, said second valve is closed to maintain said second coupling in said fully engaged position, and said actuator operates said first valve to engage and disengage said first coupling to selectively distribute power between said primary set of wheels and said secondary set of wheels

8. A two-coupling all-wheel drive system for a vehicle, comprising:
a first coupling operably associated with a primary set of wheels and a secondary set of wheels;
a second coupling operably associated with said secondary set of wheels;
a first valve operably associated with said first coupling;
a second valve operably associated with said second coupling;
an actuator for directing fluid through said first valve to said first coupling and for directing fluid through said second valve to said second coupling; and
wherein said actuator transfers fluid through said first valve to engage said first coupling, transferring power from said primary set of wheels to said secondary set of wheels, or said actuator transfers fluid through said second valve to engage said second coupling to distribute power between said secondary set of wheels.

9. The two-coupling all-wheel drive system of claim 8, wherein said first coupling is comprised of a first clutch pack and a first hydraulic piston.

10. The two-coupling all-wheel drive system of claim 9, wherein fluid is transferred through said first valve to build pressure behind said first hydraulic piston to engage said first clutch pack.

11. The two-coupling all-wheel drive system of claim 8, wherein said second coupling is comprised of a second clutch pack and a second hydraulic piston.

12. The two-coupling all-wheel drive system of claim 11, wherein fluid is transferred through said second valve to build pressure behind said second hydraulic piston to engage said second clutch pack.

13. The two-coupling all-wheel drive system of claim 8, wherein said actuator is further comprised of a motor, a ball screw, and a displacement piston.

14. The two-coupling all-wheel drive system of claim 8, wherein when said first coupling is fully engaged, power is evenly split between said primary set of wheels and said secondary set of wheels.

15. The two-coupling all-wheel drive system of claim 8, wherein when said first coupling is partially engaged, power is partially split between said primary set of wheels and said secondary set of wheels.

16. The two-coupling all-wheel drive system of claim 8, wherein when said second coupling is fully engaged, power is evenly split between said secondary set of wheels.

17. The two-coupling all-wheel drive system of claim 8, wherein when said second coupling is partially engaged, power is partially split between said secondary set of wheels.

18. The two-coupling all-wheel drive system of claim 8, further comprising at least one mode of operation where said first coupling is fully engaged, said first valve is closed to maintain said first coupling in said fully engaged position, and said actuator operates said second valve to selectively distribute power to said secondary set of wheels.

19. The two-coupling all-wheel drive system of claim 8, further comprising at least one mode of operation where said second coupling is fully engaged, said second valve is closed to maintain said second coupling in said fully engaged position, and said actuator operates said first valve to selectively distribute power between said primary set of wheels and said secondary set of wheels.

20. A method of balancing power distribution in a motor vehicle, comprising the steps of:
providing a primary set of wheels;
providing a secondary set of wheels;
providing a first coupling operably associated with said primary set of wheels and said secondary set of wheels;
providing a second coupling operably associated with said secondary set of wheels;
providing a first valve operably associated with said first coupling;
providing a second valve operably associated with said second coupling;
providing a hydraulic actuator operably associated with said first valve and said second valve;
controlling said first valve and said second valve with said hydraulic actuator;
directing fluid through said first valve to actuate said first coupling with said hydraulic actuator;
directing fluid through said second valve to said second coupling with said hydraulic actuator;
selectively engaging said first coupling to split power between said primary wheels and said secondary wheels;
selectively engaging said second coupling to split power between said secondary wheels; and
wherein said hydraulic actuator directs fluid through said first valve to engage said first coupling, or through said second valve to engage said second coupling.

21. The method of balancing power distribution of claim 20, further comprising the step of equally distributing power between said primary set of wheels and said secondary set of wheels by fully engaging said first coupling.

22. The method of balancing power distribution of claim 20, further comprising the step of evenly splitting power between said secondary set of wheels by fully engaging said second coupling.

23. The method of balancing power distribution of claim 20, further comprising the steps of:
fully engaging said first coupling; and
using said actuator to selectively actuate said second coupling to selectively balance power between said secondary set of wheels.

24. The method of balancing power distribution of claim 20, further comprising the steps of:
fully engaging said second coupling; and
using said actuator to selectively actuate said first coupling to selectively distribute power from said primary wheels to said secondary wheels.

25. The method of balancing power distribution of claim 20, further comprising the steps of:
selectively actuating said first coupling to distribute power from said primary wheels to said secondary wheels; and
actuating said second coupling to split power between said secondary set of wheels.

26. The method of balancing power distribution of claim 20, further comprising the steps of:
providing said actuator with a motor, a ball screw connected to a piston, and an elongated cylinder.

27. The method of balancing power distribution of claim 26, further comprising the steps of:
rotating said ball screw with said motor;
translating said piston in said elongated cylinder as said ball screw rotates, causing fluid to be forced through said first valve or said second valve; and
delivering fluid through said first valve or said second valve as said piston translates in said elongated cylinder.
